(19) United States
(12) Patent Application Publication
(10) Pub. No.: US 2025/0337783 A1
(43) Pub. Date: Oct. 30, 2025

(54) GRAVITY-BASED RECOMMENDATION EXPERIENCE IN GRAPH FORM FOR LARGE SCALE MANAGEMENT

(71) Applicant: Dell Products L.P., Round Rock, TX (US)

(72) Inventors: Shelly Goldblit, Haifa (IL); Jehuda Shemer, Kfar Saba (IL); Harel Mazor, Ramot Menashe (IL); Reut Kovetz, Tel Aviv (IL); Nisreen Awad, Nazareth (IL); Ofir Ezrielev, Be’er Sheva (IL)

(21) Appl. No.: 18/645,690

(22) Filed: Apr. 25, 2024

(51) Int. Cl. H04L 9/40

(52) U.S. Cl. CPC H04L 63/20

(57) ABSTRACT

An interactive graph for dynamically displaying relationships between assets of a computing system and policies is disclosed. In the interactive graph, policies may be clustered using policy parameters and assets may be clustered using asset parameters. Whenever any of the parameters are changed, the graph is updated such that the impact of the changes or adjustments are visible. Policies can be applied to unprotected assets by dragging an unprotected asset into a policy or policy cluster. The interactive graph may provide a holistic view of policy-asset relationships and allows the impact of parameter adjustments to be quickly identified.

### TECHNOLOGICAL FIELD OF THE DISCLOSURE

Embodiments disclosed herein generally relate to an interactive graphical representation of computing systems. More particularly, at least some embodiments relate to systems, hardware, software, computer-readable media, and methods for graphically representing complex relationships and graphics-based asset management.

### BACKGROUND

Computing systems can be large and include a wide variety of assets, such as servers, storage systems/devices, and applications. These assets require management for various reasons. For example, many if not all of these assets are subject to data protection operations. Data protection operations can be managed using policies. However, different assets may require different policies. Stated differently, the best policies for one asset may not be the best policies for another asset even of the assets are of the same class or type.

Because a computing system may include a large number of assets, understanding the relationships between the assets, current policies, and/or recommended polices is a challenging task. Often, these relationships are represented in grid form, such as illustrated in FIG. 1, which illustrates a grid based representation 100 of relationships between assets and policies.

This grid representation can complicate the ability of an administrator to manage (e.g., control and analyze) the assets in the computing system efficiently and effectively. The grid representation is particularly challenging as the number of assets increases. More specifically, textually representing data in tables or using non-scalable graphical representations have little utility in the context of making informed decisions. For large numbers of assets in particular, these representations make it difficult to make policy decisions in a manner that accounts for a holistic view of the system.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of a grid representation asset information;

FIG. 2 discloses aspects of a gravity forces graph;

FIG. 3 discloses aspects of an interactive graph that conveys relationships between assets, policies, and/or recommended policies;

FIG. 4A discloses aspects of customizing an interactive graph;

FIG. 4B discloses additional aspects of setting parameters for an interactive graph;

FIGS. 4C and 4D disclose aspects of an impact of changing parameters on an interactive graph;

FIG. 4E discloses aspects of accepting or declining policy recommendations via an interactive graph;

FIG. 4F discloses aspects of associating an asset to a policy in an interactive graph;

FIG. 5 discloses aspects of a method for managing assets and policies in a computing system; and

FIG. 6 discloses aspects of a computing device, system, and/or entity.

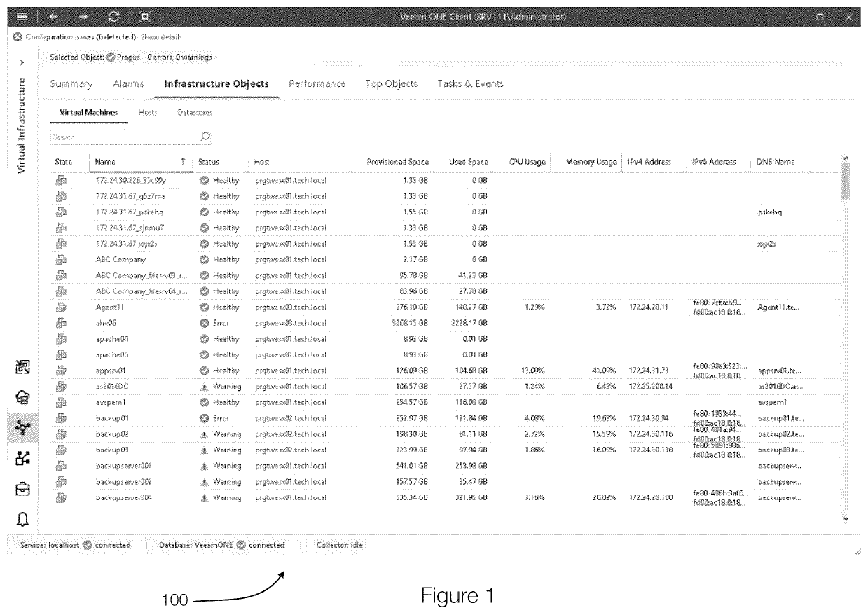

### DETAILED DESCRIPTION OF SOME EXAMPLE EMBODIMENTS

Embodiments disclosed herein generally relate to managing relationships between policies and assets in a computing system. More particularly, at least some embodiments relate to systems, hardware, software, computer-readable media, and methods for an interactive graphical representation of relationships between assets and policies. Managing relationships may include controlling policy-asset relationships, associating policies to assets, evaluating changes to policy and/or asset related parameters, or the like.

Embodiments of the invention are discussed with respect to data protection and data protection systems. Embodiments of the invention may be implemented in other domains including domains that include many-to-many assignments/relationships and management at scale is applicable.

Embodiments of the invention relate to graphically and interactively representing relationships between computing-related assets, policies, and/or policy recommendations. A graphic and interactive representation allows the impact of changes to be visually illustrated prior to committing the changes and may provide a holistic view of the impact. In one example, an interactive gravity force graph is an example of a user interface that may illustrate one or more of i) assets that are protected by at least one policy and ii) assets that are not protected by a policy. In other words, the relationships between protected/unprotected assets and policies may be illustrated in an interactive graph. Polices recommended for unprotected assets may be illustrated. Policy changes for protected assets may also be illustrated.

In one example, policies may be represented as gravitational entities in the graph and assets may be illustrated in proximity to suitable or most recommended policies based on various criteria and/or multiple parameters. In one example, the gravity force (e.g., the strength of the policy recommendation) may be represented as a mean average based on a rule set.

Recommendations can be applied using drag and drop actions. More specifically, an asset can be dropped on a policy to apply the policy to the asset. In addition, multiple actions can be performed with a single click or input. For example, a policy can be applied to assets and asset cluster at the same time.

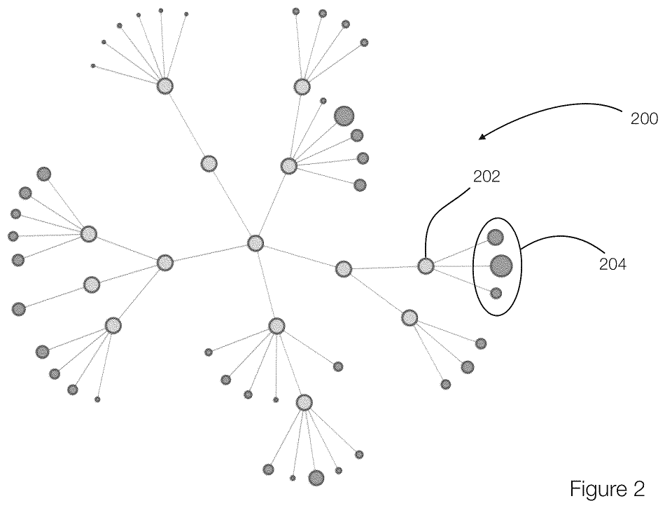

FIG. 2 discloses aspects of an interactive graphical representation of a computing system. An interactive graph can facilitate intuitive management at a large scale of assets within or subject to a data protection system.

In this example, the graph 200 illustrates relationships between policies 202 and assets 204. In some examples, the relationship between a policy and an asset may be illustrated as assigned in the graph 200 and in other examples, a relationship between a policy and an asset may be illustrated as a recommended assignment. Accepting a recommendation may be performed using a drag and drop operation by dropping the asset on the policy. The change will be visually reflected in the graph 200.

The relationships between parameters and assets can be affected using a variety of different parameters. Example parameters include, but are not limited to, size, network, change rate, asset type, sensitivity, name, security level, retention, vCenter location, password protected, load, availability, busy hours, up time, past protected, or the like or combinations thereof. When these parameters are changed or adjusted, the impact of the adjustments are graphically illustrated in the graph.

This allows a user to customize the impact of each parameter individually, in parameter groups or the like. A user may also receive immediate feedback on the impact of the change (e.g., an animated graph shift), or the like. Interactive visual feedback helps users quickly understand how each parameter impacts the current asset-policy relationships and recommended asset-policy relationships. The recommendations may also be represented as a score, which may be conveyed visually. For example, the distance of an asset node to a planetary policy node may be used as the score. Assets may be associated with multiple policies, which may include related and/or unrelated policies.

Embodiments of the invention may also incorporate clustering operations such that similar assets may be clustered and such that similar policies may be clustered. This allows a user to assign asset clusters to individual policies or to policy clusters. Clusters may also be represented in the graph.

More specifically, an asset cluster may include one or more assets. Automatic asset clustering enables asset management at a large scale at least because decisions can be made for asset clusters. This may eliminate or reduce the need to manage assets individually. Various clustering operations (e.g., nearest neighbor, hierarchical clustering) may be used to cluster assets by accounting for the parameters previously described.

Similarly, a policy cluster may include one or more policies. Automatic policy clustering, like asset clustering, also enables policy management at a large scale at least because decisions can be made in the context of policy clusters. This may eliminate or reduce the need to manage each policy individually. Clustering operations for policies may account for or be based on parameters that may include, but are not limited to, asset type, retention, estimated recovery point objective (RPO), storage target, schedule, location, replication/cloud tier, or the like or combinations thereof.

In one example, a relationship formula may be used to recommend (e.g., rank) a policy cluster for an asset cluster (or a policy for an asset). The relationship formula may be used to recommend the preferability of each policy or policy cluster. The relationship formula may be expressed as:

f({policies cluster},{assets cluster},{preferences})→{assignment recommendatinos}.

In the above equation, “recommendations” of the parameters may be co-dependent and embodiments of the invention may present, to the user, mutual relationships between the parameters and the impact that the parameters may have on each other. Examples of co-dependent parameters include, but are not limited to:
business criticality versus schedule;
storage space versus estimate RPO; and
storage type versus estimated RTO (Recovery Time Objective).

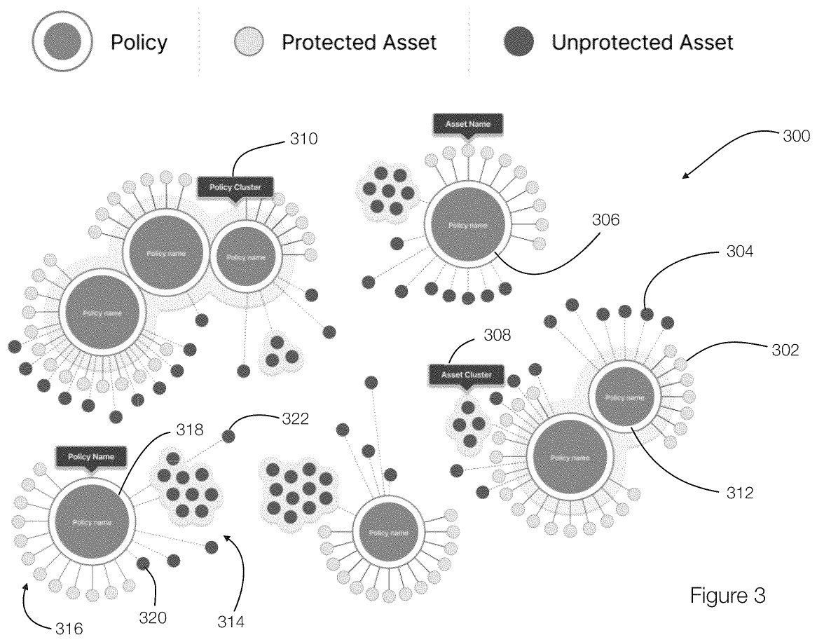

FIG. 3 discloses aspects of an interactive graph configured to visually represent relationships between policies and assets. FIG. 3 illustrates an example graph 300. In one example, the graph is fully connected. In another example, the graph 300 may be separated into portions where each portion includes a single policy or a single policy cluster. In FIG. 3, the graph 300 is separated into pieces or portions. Thus, the graph 300 illustrates individual policies, such as the policy 306, and policy clusters, such as the policy cluster 310, which includes three policies in this example.

FIG. 3 also illustrates protected assets, such as the protected asset 302 and unprotected assets, such as the unprotected asset 304. Asset clusters are represented by the asset cluster 308. Protected assets are connected to a policy using a solid line and unprotected assets are connected to a recommended policy using a dashed line in one example. In addition to lines, color schemes or the like may also be used.

In FIG. 3, proximity represents preferability. For example, with regard to the policy 318, the unprotected assets 314 are at various distances from the policy 318. The protected assets 316 are already associated with the policy 318 and their proximity represents preferability. For example, the graph 300 conveys that the policy 318 is more strongly recommended for the asset 320 than the asset 322. However, the assets 314 are more closely related to the policy 318 than other policies or policy clusters illustrated in FIG. 3. Given the proximity of the asset 320 to the policy 318, the asset 320 can be associated to the policy 318 by dragging and dropping the asset 320 onto the policy 318. Similarly, protected assets can be associated with other policies in a similar manner. Dragging a protected asset to a different policy or policy cluster removes the current asset-policy relationship and establishes a new asset-policy assignation.

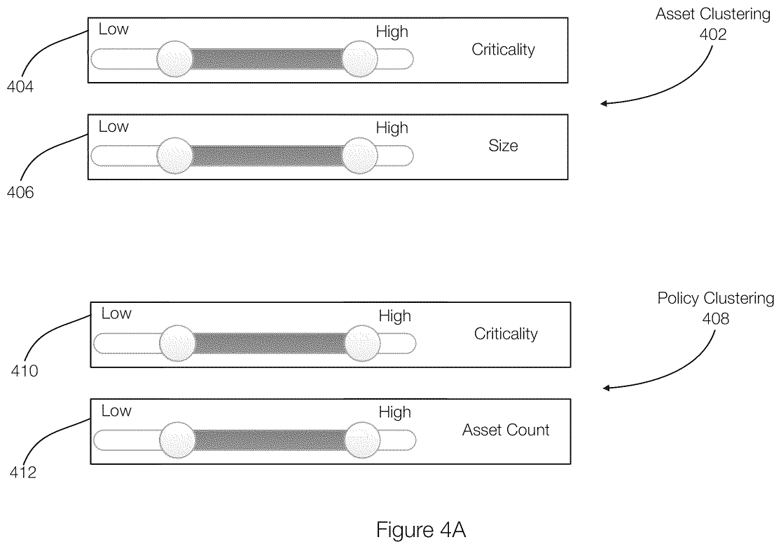

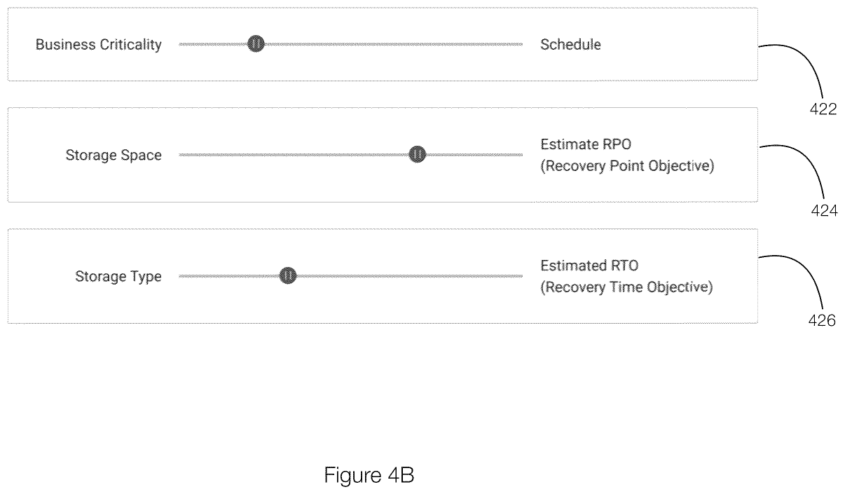

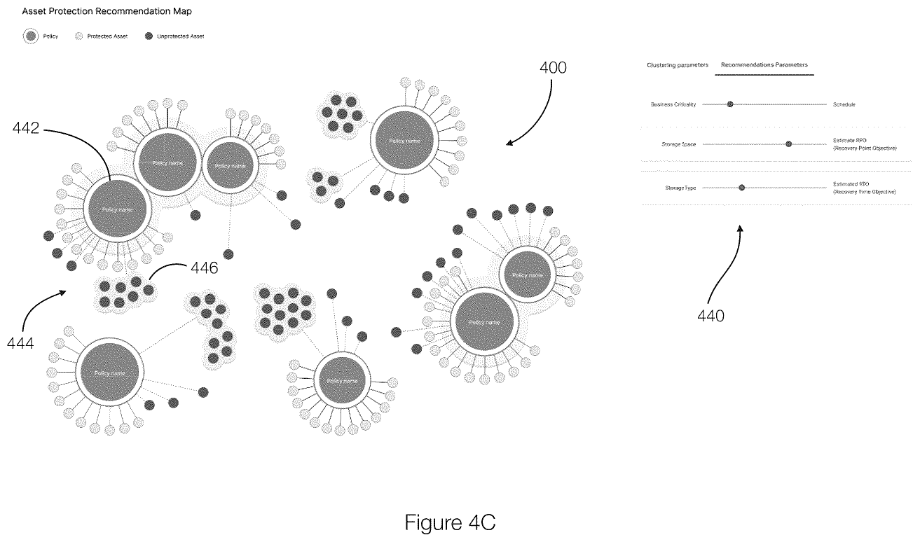

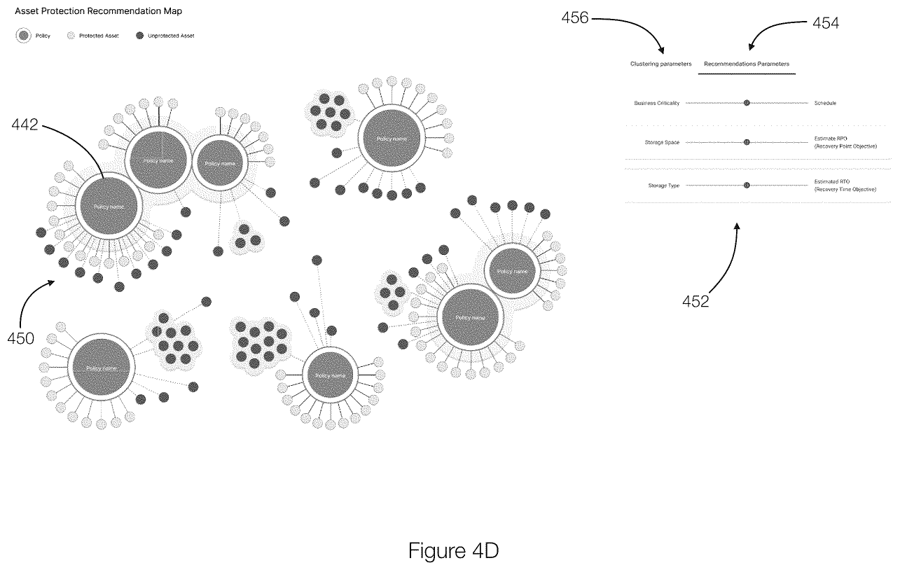

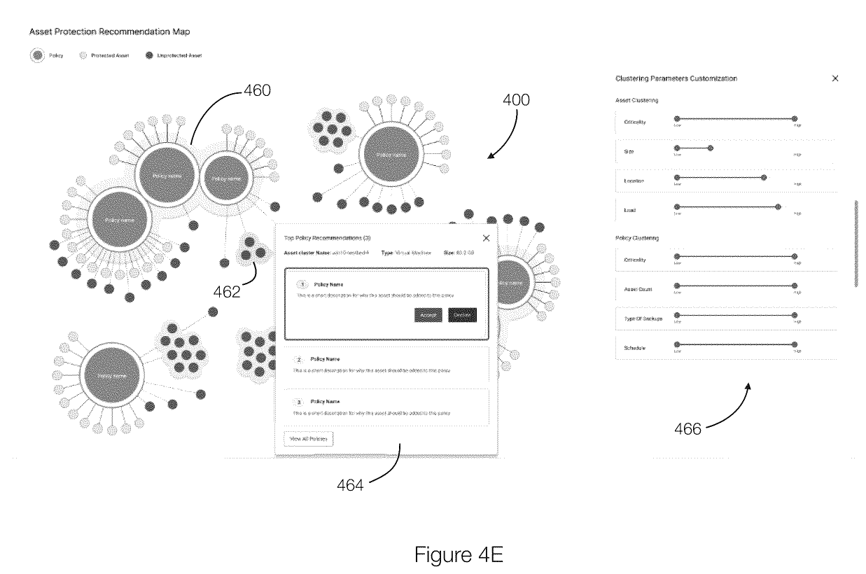

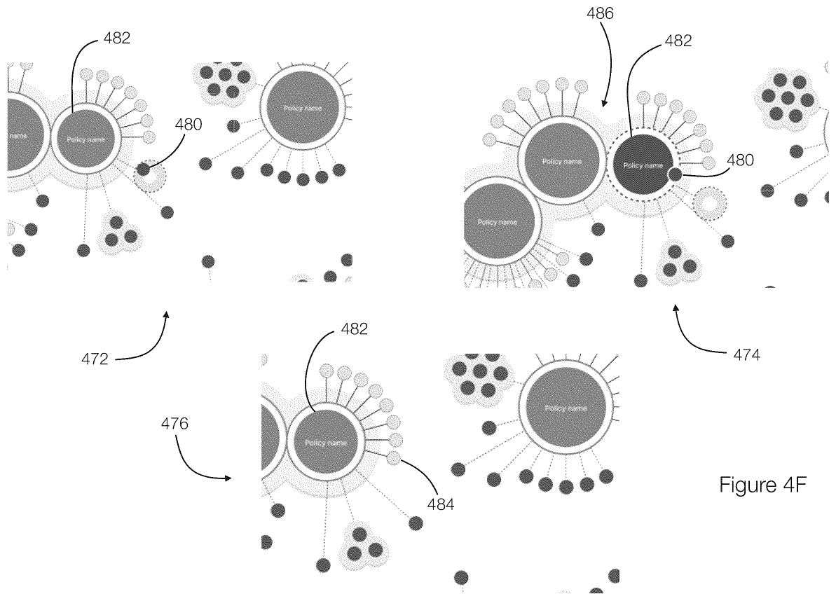

FIG. 4A illustrates an example of customizing an interactive graph. FIG. 4A more specifically illustrates an example of user interface elements that allow a graph to be customized. FIG. 4A further illustrates aspects of parameters that may impact the manner in which assets and/or policies are clustered. Changing these parameters may change the clustering illustrated in the graph. For example, asset clustering 302 can be changed or adjusted using sliders 304 and 306. The sliders 304 and 306 are examples of parameter input mechanisms. In this example, the slider 304 allows a criticality parameter to be adjusted and the slider 306 allows a size parameter to be adjusted. Other parameters related to asset clustering 302 may be present. Moving the slider generates a corresponding change in the graph.

Policy clustering 308 is similarly associated with sliders, represented by a slider 310 for a criticality parameter and a slider 312 for an asset count parameter. Other policy clustering sliders may also be provided for other parameters related to policy clustering 308.

In this example, the sliders allow the clustering parameters to be set in terms of a range between a low value and a high value. However, other sliders may be used such as sliders that allow specific values to be set. The sliders 304, 306, 310, and 312 are therefore presented by way of example. Other user interface elements may also be used to set parameter values or ranges such as dials, checkboxes, radio buttons, or the like or combinations thereof.

FIG. 4B discloses additional aspects of setting parameters for an interactive graph. More specifically, FIG. 4B illustrates aspects of setting or selecting parameters for co-dependent parameters. FIG. 4B illustrates sliders 422, 424, and 426 that may be associated with a graph such as the graph 400 (see FIGS. 4C and 4D). The sliders 422, 424, and 426, which are presented by way of example only, allow a user to balance co-dependent parameters. For instance, the slider 422 allows a user to prefer business criticality more than schedule or vice versa by setting the position of the slider. The slider 424 allows a user to select a balance between storage space and estimated RPO. The slider 426 allows a user to select a balance between storage type and estimated RTO. Moving these sliders results in changes to the graph 400.

FIGS. 4C and 4D illustrate aspects of an impact of changing parameters on an interactive graph. FIG. 4C illustrates a first parameter selection or setting 440 of parameters illustrated in FIG. 4B with respect to a graph 400. In this example, the graph is representing the impact of changes with respect to recommendations. Thus, the parameter setting 440 May be applied to the unprotected assets illustrated in FIG. 4C.

In this example, the unprotected assets 444 include an asset cluster 446. The current settings 440 suggest or recommend that the asset cluster 446 be associated to the policy cluster 442. The asset cluster 446 can be associated to the policy 442 by dragging and dropping the asset cluster 446 on the policy 442.

FIG. 4D illustrates changes in the graph when settings (or parameters) are changed. FIG. 4D illustrates a second parameter setting 452. The parameters shown in FIGS. 4C and 4D are the same and the second parameter setting 452 is different from the first parameter setting 440.

In this example, the unprotected assets 450 are associated with the policy cluster 442. By changing the settings from the settings 442 to the settings 452, the asset cluster 446 is no longer present. In fact, the assets 450 recommended for the policy 442 may be different from the assets 442 previously recommended for the policy 442 in FIG. 4C.

More generally, the interactive graph 400 allows a user to understand how each parameter impacts the preferability of each policy cluster or each policy with respect to the assets of the computing system or environment. The visual change allows a user to determine how parameter changes or adjustment impact policy recommendations for unprotected assets. The graph 400 may also be able to recommend potential policy changes for currently protected assets as well. Each of the parameters can be set individually or in groups and the impact of changes is visually presented to the user.

In one example, a user may be able to select various screens of parameters. FIG. 4D, for example, illustrates a user interface 454 for recommendations parameters and selecting a user interface 456 for clustering parameters will illustrate a different set of parameters. Other parameters may be illustrated in other user interfaces.

FIG. 4E discloses aspects of accepting or declining policy recommendations. In this example, an asset cluster 462 has been dragged into the policy cluster 460. Thus, the assets in the asset cluster 462 will be associated with each of the policies (3 in this example) in the policy cluster 460. A user may be presented with a dialog box 464 such that the user can confirm the assignation. The dialog box 464 may provide additional information such as policy names, asset identifiers, or the like. In one example, a user may have the ability to select which of the policies in the policy cluster 460 will be applied to the assets in the asset cluster 462. More generally, however, all policies in the cluster 460 are applied to all assets being associated to the policy cluster 460. In this example, the visual representation of the graph 400 is based on asset clustering and policy clustering settings 466, which is another example of a user interface for setting or selecting clustering parameters.

FIG. 4F discloses aspects of associating an asset to a policy. FIG. 4F illustrates partial representations 472, 474, and 476 of the graph 400. In the representation 472, an asset 480 is selected. In the representation 474, the asset 480 is dragged into the policy 482. In the representation 476, the unprotected asset 480 becomes a protected asset 484 that is associated with the policy 482 and/or all policies in the policy cluster 486. As illustrated in FIG. 4F, the line connecting the asset 480 to the policy 482 changes from dashed to solid once the policy-asset relationship is assigned or accepted (e.g., as illustrated in FIG. 4E).

Embodiments of the invention relate to an interactive gravity graph to describe complex relationships between protection entities. This allows intuitive management at scale of data protection entities using customizable auto-clustering and by suggesting preference-based recommendations.

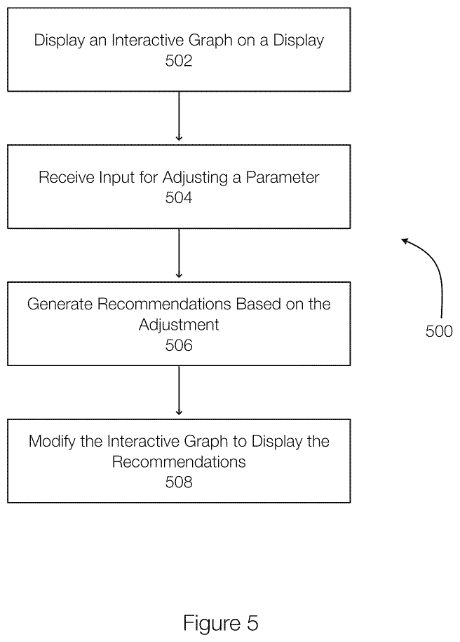

FIG. 5 discloses aspects of a method for managing assets and policies in a computing system. The method 500 includes displaying 502 an interactive graph (e.g., a gravity graph) on a display of a computing device. This may be displayed to a system administrator. The interactive graph may include policy nodes that are each associated with a policy and asset nodes that are each associated with an asset of the computing system. The graph lines generally represent relationships between the policies and the assets. The assets include protected and unprotected assets. In one example, the interactive graph may illustrate recommendations. The recommendations may recommend which policies to associate to which assets.

In some examples, clustering operations may be performed to cluster the policies and/or the assets. This allows multiple assets to be assigned to multiple policies at the same time. The clustering operations may be based on policy parameters (for policy clustering) and asset parameters (for asset clustering).

The graph may include a user interface configured to receive 504 input (e.g., via sliders) to adjust one or more parameters. Policy parameters, asset parameters, co-dependent parameters, and others may be adjusted. Recommendations are determined 506 based on the parameter adjustments.

The graph is modified 508 to display the recommendations (and other aspects of the graph) in a visual manner. Thus, the impact of parameter changes is visually conveyed to a user. The user may have a holistic view of a computing system when changing or adjusting one or more parameters. For example, the impact of changing or adjusting asset clustering parameters can be viewed in conjunction with or independently of policy clustering parameters. The impact of adjusting co-dependent parameters can also be viewed. Also, policies can be applied to assets by dragging an unprotected asset into a policy or policy cluster. An asset can be removed by dragging the asset away from the policy or policy cluster.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, clustering operations, interactive graph operations, scaling operations, asset management operations, visualized asset management operations, policy recommendation operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable perform operations initiated by one or more clients or other elements of the operating environment.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments may be employed include, but are not limited to, Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ is intended to be broad in scope. Example embodiments are applicable to any system capable of storing and handling various types of objects, in analog, digital, or other form.

It is noted that any operations of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.
Embodiment 1. A method comprising: displaying an interactive graph on a display of a computing device, wherein the interactive graph includes policy nodes and asset nodes and wherein the interactive graph illustrates relationships between the policy nodes and the asset nodes, wherein each of the policy nodes is associated with a policy and each of the asset nodes is associated with an asset, receiving input at the computing device related to adjusting at least one parameter associated with the interactive graph, generating recommendations for assigning unprotected assets to a policy, and modifying the interactive graph such that the recommendations are presented visually, wherein the assets include protected assets and unprotected assets, wherein the recommendations are graphically illustrated and identify which of the policies are recommended for which of the assets.
Embodiment 2. The method of embodiment 1, further comprising performing an asset clustering operation to cluster the assets based on asset clustering parameters.
Embodiment 3. The method of embodiment 1 and/or 2, wherein the asset clustering parameters include one or more of a size, a network, a change rate, an asset type, a sensitivity, a name, a security level, a retention, password protected, load, availability, busy hours, up time, and/or past protected.
Embodiment 4. The method of embodiment 1, 2, and/or 3, further comprising adjusting at least one of the asset clustering parameters and modifying the interactive graph such that changes in the interactive graph related to the adjusted at least one of the asset clustering parameters are displayed.
Embodiment 5. The method of embodiment 1, 2, 3, and/or 4, further comprising performing a policy clustering operation to cluster the policies based on policy clustering parameters.
Embodiment 6. The method of embodiment 1, 2, 3, 4, and/or 5, wherein the policy clustering parameters include one or more of asset type, retention, estimated recovery point objective, storage target, schedule, location, and/or replication/cloud tier.
Embodiment 7. The method of embodiment 1, 2, 3, 4, 5, and/or 6, further comprising adjusting at least one of the policy clustering parameters and modifying the interactive graph such that changes in the interactive graph related to the adjusted at least one of the policy clustering parameters are displayed.
Embodiment 8. The method of embodiment 1, 2, 3, 4, 5, 6, and/or 7, further comprising adjusting co-dependent parameters and modifying the interactive graph such that changes in the interactive graph related to the adjusted co-dependent parameters are displayed.
Embodiment 9. The method of embodiment 1, 2, 3, 4, 5, 6, 7, and/or 8, further comprising dragging an unprotected asset node onto a policy node or a policy cluster to assign corresponding policies to the corresponding asset.
Embodiment 10. The method of embodiment 1, 2, 3, 4, 5, 6, 7, 8, and/or 9, further comprising executing a function to determine a preferability of each policy cluster to protect an asset cluster, wherein the function is based on user preferences and parameters.
Embodiment 11. A system, comprising hardware and/or software, operable to perform any of the operations, methods, or processes, or any portion of any of these, disclosed herein.
Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

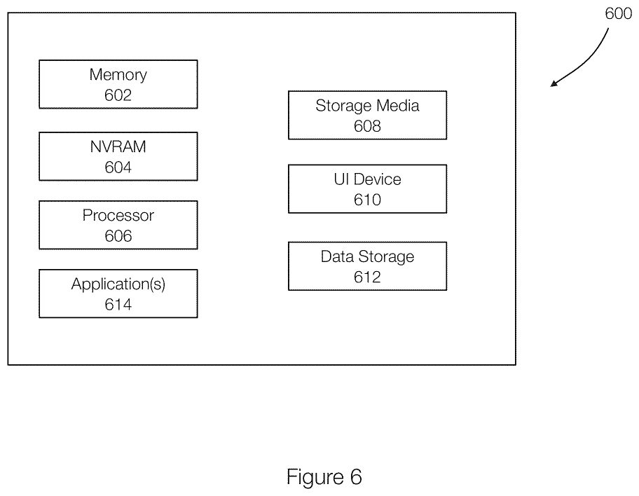

With reference briefly now to FIG. 6, any one or more of the entities disclosed, or implied the Figures and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for managing assets in a computing system, the method comprising:
displaying an interactive graph on a display of a computing device, wherein the interactive graph includes policy nodes and asset nodes and wherein the interactive graph illustrates relationships between the policy nodes and the asset nodes, wherein each of the policy nodes is associated with a policy and each of the asset nodes is associated with an asset;
receiving input at the computing device related to adjusting at least one parameter associated with the interactive graph;
generating recommendations for assigning unprotected assets to a policy; and
modifying the interactive graph such that the recommendations are presented visually, wherein the assets include protected assets and unprotected assets, wherein the recommendations are graphically illustrated and identify which of the policies are recommended for which of the assets.

2. The method of claim 1, further comprising performing an asset clustering operation to cluster the assets based on asset clustering parameters.

3. The method of claim 2, wherein the asset clustering parameters include one or more of a size, a network, a change rate, an asset type, a sensitivity, a name, a security level, a retention, password protected, load, availability, busy hours, up time, and/or past protected.

4. The method of claim 2, further comprising adjusting at least one of the asset clustering parameters and modifying the interactive graph such that changes in the interactive graph related to the adjusted at least one of the asset clustering parameters are displayed.

5. The method of claim 1, further comprising performing a policy clustering operation to cluster the policies based on policy clustering parameters.

6. The method of claim 5, wherein the policy clustering parameters include one or more of asset type, retention, estimated recovery point objective, storage target, schedule, location, and/or replication/cloud tier.

7. The method of claim 5, further comprising adjusting at least one of the policy clustering parameters and modifying the interactive graph such that changes in the interactive graph related to the adjusted at least one of the policy clustering parameters are displayed.

8. The method of claim 1, further comprising adjusting co-dependent parameters and modifying the interactive graph such that changes in the interactive graph related to the adjusted co-dependent parameters are displayed.

9. The method of claim 1, further comprising dragging an unprotected asset node onto a policy node or a policy cluster to assign corresponding policies to the corresponding asset.

10. The method of claim 1, further comprising executing a function to determine a preferability of each policy cluster to protect an asset cluster, wherein the function is based on user preferences and parameters.

11. A non-transitory storage medium having stored therein instructions that are executable by one or more hardware processors to perform operations comprising:
displaying an interactive graph on a display of a computing device, wherein the interactive graph includes policy nodes and asset nodes and wherein the interactive graph illustrates relationships between the policy nodes and the asset nodes, wherein each of the policy nodes is associated with a policy and each of the asset nodes is associated with an asset;
receiving input at the computing device related to adjusting at least one parameter associated with the interactive graph;
generating recommendations for assigning unprotected assets to a policy; and
modifying the interactive graph such that the recommendations are presented visually, wherein the assets include protected assets and unprotected assets, wherein the recommendations are graphically illustrated and identify which of the policies are recommended for which of the assets.

12. The non-transitory storage medium of claim 11, further comprising performing an asset clustering operation to cluster the assets based on asset clustering parameters.

13. The non-transitory storage medium of claim 12, wherein the asset clustering parameters include one or more of a size, a network, a change rate, an asset type, a sensitivity, a name, a security level, a retention, password protected, load, availability, busy hours, up time, and/or past protected.

14. The non-transitory storage medium of claim 12, further comprising adjusting at least one of the asset clustering parameters and modifying the interactive graph such that changes in the interactive graph related to the adjusted at least one of the asset clustering parameters are displayed.

15. The non-transitory storage medium of claim 11, further comprising performing a policy clustering operation to cluster the policies based on policy clustering parameters.

16. The non-transitory storage medium of claim 15, wherein the policy clustering parameters include one or more of asset type, retention, estimated recovery point objective, storage target, schedule, location, and/or replication/cloud tier.

17. The non-transitory storage medium of claim 15, further comprising adjusting at least one of the policy clustering parameters and modifying the interactive graph such that changes in the interactive graph related to the adjusted at least one of the policy clustering parameters are displayed.

18. The non-transitory storage medium of claim 11, further comprising adjusting co-dependent parameters and modifying the interactive graph such that changes in the interactive graph related to the adjusted co-dependent parameters are displayed.

19. The non-transitory storage medium of claim 11, further comprising dragging an unprotected asset node onto a policy node or a policy cluster to assign corresponding policies to the corresponding asset.

20. The non-transitory storage medium of claim 11, further comprising executing a function to determine a preferability of each policy cluster to protect an asset cluster, wherein the function is based on user preferences and parameters.
